(19) United States
(12) Patent Application Publication
(10) Pub. No.: US 2004/0062977 A1
(43) Pub. Date: Apr. 1, 2004

(54) Fuel cell power packs and methods of making such packs

(75) Inventors: Mehmet Suha Yazici, Parma Heights, OH (US); Thomas William Weber, Cleveland, OH (US); Robert Angelo Mercuri, Seven Hills, OH (US)

Correspondence Address: Melissa A. Carr, Advanced Energy Technology Inc., 12900 Snow Road, Parma, OH, 44130, US

(73) Assignee: Graftech, Inc., Wilmington, DE

(21) Appl. No.: 10/261,856

(22) Filed: Oct. 1, 2002

(51) Int. Cl. H01M 8/02; H01M 4/94; H01M 8/24

(52) U.S. Cl. 429/38; 429/44

(57) ABSTRACT

The invention relates to power packs, which comprises a plurality of fuel cells and a reactant supply element. In one embodiment, the power pack comprises a reactant supply element for a reactant comprising one of a fuel or an oxidant; and a plurality of cylindrical fuel cells. The reactant supply element is aligned with the plurality to be capable to deliver the reactant to more than one fuel cell of the plurality. In a second embodiment, the power pack comprises a reactant supply element for a reactant comprising a fuel and a plurality of fuel cells attached to the reactant supply element. At least two of the plurality are removably attached to the reactant supply element, and the power pack comprises a passive oxidant supply.

### FIELD OF THE INVENTION

This invention relates to the use of fuel cells to supply power to a device, and particularly to fuel cell power packs for a device and methods to make such power packs.

### BACKGROUND OF THE INVENTION

An ion exchange membrane fuel cell, more specifically a proton exchange membrane (PEM) fuel cell, produces electricity through the electro-chemical reaction of hydrogen and oxygen in the air. Within the fuel cell, electrodes, denoted as anode and cathode, surround a polymer electrolyte to form what is generally referred to as a membrane electrode assembly, or MEA. Oftentimes, the electrodes also function as the gas diffusion layer (or GDL) of the fuel cell. A catalyst material stimulates a fuel, e.g., hydrogen or methanol, to split into hydrogen ions (protons) and electrons. The electrons are utilized as electrical energy. The protons migrate through the electrolyte and combine with oxygen and electrons to form water.

A PEM fuel cell includes a membrane electrode assembly sandwiched between two graphite flow field plates. Conventionally, the membrane electrode assembly consists of random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes. In operation, hydrogen flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which joins with the protons through the proton exchange membrane and the electrons through the circuit, and combine to form water. Since the membrane is an insulator, the electrons travel through an external circuit in which the electricity is utilized, and join with protons at the cathode. An air stream on the cathode side is one mechanism by which the water formed by combination of the hydrogen and oxygen is removed. Combinations of such fuel cells are used in a fuel cell stack to provide the desired voltage.

The flow field plates have a continuous reactant flow channel with an inlet and an outlet. The inlet is connected to a source of fuel in the case of an anode flow field plate, or a source of oxidant in the case of a cathode flow field plate. When assembled in a fuel cell stack, each flow field plate functions as a current collector.

Electrodes, also sometimes referred to as gas diffusion layers, may be formed by providing a graphite sheet as described herein and providing the sheet with channels, which are preferably smooth-sided, and which pass between the parallel, opposed surfaces of the flexible graphite sheet and are separated by walls of compressed expandable graphite. It is the walls of the flexible graphite sheet that actually abut the ion exchange membrane, when the inventive flexible graphite sheet functions as an electrode in an electrochemical fuel cell.

Advantageously, the channels are formed in the flexible graphite sheet at a plurality of locations by mechanical impact. Thus, a pattern of channels is formed in the flexible graphite sheet. That pattern can be devised in order to control, optimize or maximize fluid flow through the channels, as desired. For instance, the pattern formed in the flexible graphite sheet can comprise selective placement of the channels, as described, or it can comprise variations in channel density or channel shape in order to, for instance, equalize fluid pressure along the surface of the electrode when in use, as well as for other purposes which would be apparent to the skilled artisan.

The impact force is preferably delivered using a patterned roller, suitably controlled to provide well-formed perforations in the graphite sheet. In the course of impacting the flexible graphite sheet to form channels, graphite is displaced within the sheet to disrupt and deform the parallel orientation of the expanded graphite particles. In effect the displaced graphite is being “die-molded” by the sides of adjacent protrusions and the smooth surface of the roller. This can reduce the anisotropy in the flexible graphite sheet and thus increase the electrical and thermal conductivity of the sheet in the direction transverse to the opposed surfaces. A similar effect is achieved with frusto-conical and parallel-sided peg-shaped flat-ended protrusions.

Graphites are made up of layer planes of hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional e.g. thermal and electrical conductivity and fluid diffusion.

Briefly, graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation

As noted above, the bonding forces holding the parallel layers of carbon atoms together are only weak van der Waals forces. Natural graphites can be treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been greatly expanded and more particularly expanded so as to have a final thickness or “c” direction dimension which is as much as about 80 or more times the original “c” direction dimension can be formed without the use of a binder into cohesive or integrated sheets of expanded graphite, e.g. webs, papers, strips, tapes, foils, mats or the like (typically referred to as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles.

In addition to flexibility, the sheet material, as noted above, has also been found to possess a high degree of anisotropy with respect to thermal and electrical conductivity and fluid diffusion, comparable to the natural graphite starting material due to orientation of the expanded graphite particles and graphite layers substantially parallel to the opposed faces of the sheet resulting from very high compression, e.g. roll pressing. Sheet material thus produced has excellent flexibility, good strength and a very high degree of orientation.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance, once compressed, will maintain the compression set and alignment with the opposed major surfaces of the sheet. The density and thickness of the sheet material can be varied by controlling the degree of compression. The density of the sheet material can be within the range of from about 0.04 g/cc to about 2.0 g/cc. The flexible graphite sheet material exhibits an appreciable degree of anisotropy due to the alignment of graphite particles parallel to the major opposed, parallel surfaces of the sheet, with the degree of anisotropy increasing upon roll pressing of the sheet material to increased density. In roll pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

Methods of manufacturing articles from graphite particles have been proposed. For example, U.S. Pat. No. 5,882,570 to Hayward discloses a method of grinding flexible unimpregnated graphite foil to a small particle size, thermally shocking the particles to expand them, mixing the expanded graphite with a thermoset phenolic resin, injection molding the mixture to form low density blocks or other shapes, then heat treating the blocks to thermoset the material. The resulting blocks may be used as insulating material in a furnace or the like. WO 00/54953 and U.S. Pat. No. 6,217,800, both to Hayward further describe processes related to those of U.S. Pat. No. 5,882,570.

With respect to the art of fuel cells, a need exists to determine techniques and devices to supply the reactants (e.g., hydrogen, oxygen, or both) to a plurality of cylindrical fuel cells such that the plurality of cells can be used as a power source for an electrical device, e.g., a cellular telephone. The present invention will address this need.

### SUMMARY OF THE INVENTION

The aspects of the invention include a power pack. Preferably, one embodiment of the power pack comprises a reactant supply element for a reactant comprising one of a fuel or an oxidant. The power pack may further comprise a plurality of cylindrical fuel cells. Preferably, the reactant supply element is aligned with the plurality to be capable to deliver the reactant to more than one of the plurality.

An additional aspect of the invention includes an electrical power source. An inventive embodiment of the power source may comprise a removable power assembly, which includes a fuel supply element and a plurality of cylindrical fuel cells. Preferably the fuel supply element is aligned with the plurality to be capable to deliver a fuel to more than one of the plurality.

A further aspect of the invention is an electrical device. An embodiment of the device may include a reactant supply element for a reactant comprising one of a fuel or an oxidant and a power source. Preferably the power source comprises a plurality of cylindrical fuel cells. The power source may be connected to the device such that the power source may provide power to the device. It is also preferred that the reactant supply element is aligned with the plurality, such that the supply element is capable of delivering the reactant to more than one of the plurality. Examples of preferred electrical devices include at least one of a cellular telephone, a pager, digital video equipment, a personal digital assistant, or a portable computer.

Furthermore aspects of the invention include another embodiment of a power pack. In this embodiment the inventive power pack comprises a reactant supply element for a reactant comprising one of a fuel or an oxidant. The power pack further includes a plurality of fuel cells attached to the reactant supply element. Preferably at least two of the plurality of fuel cells are removably attached to the reactant supply element.

Numerous advantages may be realized by practicing the present invention. One advantage of the invention is that it will enable the use of fuel cells in portable electrical devices as well as stationary electrical devices. The advantages include the ability to incorporate a removable fuel cell power pack into a device, preferably a portable device. The advantages further include the ability to have a fuel cell power pack in which one or more individual fuel cells may be removable. The advantages to removing the power pack or individual fuel cells of the power pack include the ability to replace a defective or worn out power pack or fuel cell. This ability to remove improves the convenience of using fuel cells in such devices and also makes fuel cells a more cost-effective technology as a power source.

Other advantages include the ability to deliver reactants such as a fuel or an oxidant to a plurality of cylindrical fuel cells, wherein the fuels cells are in a parallel orientation, series orientation, or some combination thereof. A further advantage of the invention is a novel technique for storing fuel or the oxidant inside the power pack.

The inventive power pack can be configured to have an advantageous power density relative to the weight and volume of the power pack in comparison to competing power technologies such as alkaline batteries. Also another advantage of the inventive power pack is the inventive pack can configured to fit into compact spaces. Furthermore, the invention may be used to boast the voltage output of the power pack.

A further advantage of the inventive power pack is that a particular fuel cell of the plurality of fuel cells may be removed from the plurality and the power pack may be operated without the use of a dummy fuel cell in place of the removed fuel cell. Preferably a sealing element is used to prevent the supply of reactant from the supply element to the location of the removed fuel cell. The sealing element may comprise a plug, a patch, a cover, or any other suitable element to inhibit flow into an opening.

The inventive power pack also includes the advantage of having an open space around each fuel cell of the plurality. In the case of a fuel cell with an exterior surface as a cathode, the open space may function as the source of oxidant, such as air, for any particular fuel cell.

Another advantage of the invention is that the invention is applicable to direct methanol fuel (“DMF”) systems. Preferably the DMF system may use an alcohol (e.g., methanol, ethanol, propane, etc.) as a fuel without the use of a reformer.

Additional features and advantages of the invention will be set forth in the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a top view of an embodiment of a power pack in accordance with the present invention.

FIG. 2 is a top view of an embodiment of a supply element of the power pack in accordance with the invention.

FIG. 3 is a side view of a further embodiment of the power pack in accordance with the invention.

FIG. 4 is a side view of an additional embodiment of the power pack in accordance with the invention.

FIG. 5 is a top view of another embodiment of the power pack in accordance with the invention.

FIG. 6 is a block schematic view of a fuel cell in FIG. 5.

FIG. 7 is a top view of a plurality of cylindrical fuel cells connected in parallel.

FIG. 8 is a top view of a plurality of cylindrical fuel cells connected in series.

FIG. 9 is a top view of a supply element for a plurality of planar fuel cells made in accordance with the invention.

FIG. 10 is a side view of a power pack including a plurality of planar fuel cells made in accordance with the invention.

FIG. 11 is a side view of an additional embodiment of the power pack having two rows of planar fuel cells in accordance with the invention.

FIG. 12 is a top view of a pair of flow field plates connected in a series alignment in accordance with the invention.

FIG. 13 is a top view of a plurality of fuel cells connected in parallel to one another in accordance with the invention.

FIGS. 14-18 are schematic views of a method of making a plurality of planar fuel cells connected in series in accordance with the invention.

FIG. 19 is an embodiment of the inventive power pack which includes the optional additional elements of a fuel cartridge, a battery, a capacitor, and a converter.

### DETAILED DESCRIPTION OF THE INVENTION

Graphite is a crystalline form of carbon comprising atoms covalently bonded in flat layered planes with weaker bonds between the planes. By treating particles of graphite, such as natural graphite flake, with an intercalant of, e.g., a solution of sulfuric and nitric acid, the crystal structure of the graphite reacts to form a compound of graphite and the intercalant. The treated particles of graphite are hereafter referred to as “particles of intercalated graphite”. Upon exposure to high temperature, the particles of intercalated graphite expand in dimension as much as 80 or more times its original volume in an accordion-like fashion in the “c” direction, i.e., in the direction perpendicular to the crystalline planes of the graphite. The exfoliated graphite particles are vermiform in appearance, and are therefore commonly referred to as worms. The worms may be compressed together into flexible sheets, which, unlike the original graphite flakes, can be formed and cut into various shapes and provided with small transverse openings by deforming mechanical impact.

Graphite starting materials for the flexible sheets suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials for the flexible sheets used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has an ash content of less than twenty weight percent. More preferably, the graphite employed for the present invention will have a purity of at least about 94%. In the most preferred embodiment, the graphite employed will have a purity of at least about 99%.

A common method for manufacturing graphite sheet, e.g., foil from flexible graphite, is described by Shane et al. in U.S. Pat. No. 3,404,061 the disclosure of which is incorporated herein by reference. In the typical practice of the Shane et al. method, natural graphite flakes are intercalated by dispersing the flakes in a solution containing an oxidizing agent of, e.g., a mixture of nitric and sulfuric acid, advantageously at a level of about 20 to about 300 parts by weight of intercalant solution per 100 parts by weight of graphite flakes (pph). The intercalation solution may contain at least one oxidizing agent and one or more intercalating agents. Examples of intercalation solutions include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g., trifluoroacetic acid, and a strong oxidizing agent soluble in the organic acid. Alternatively, an electric potential can be used to bring about oxidation of graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, e.g., nitric acid, perchloric acid, chromic acid, potassium permanganate, hydrogen peroxide, iodic or periodic acids, or the like. Although less preferred, the intercalation solutions may contain metal halides such as ferric chloride, and ferric chloride mixed with sulfuric acid, or a halide, such as bromine as a solution of bromine and sulfuric acid or bromine in an organic solvent.

After the flakes are intercalated, any excess solution is drained from the flakes and the flakes are water-washed. The washed particles of intercalated graphite are sometimes referred to as “residue compounds.” The quantity of intercalation solution retained on the flakes after draining may range from about 20 to about 150 parts of solution by weight per about 100 parts by weight of graphite flakes (pph) and more typically about 50 to about 120 pph. Alternatively, the quantity of the intercalation solution may be limited to between about 10 to about 50 parts of solution per hundred parts of graphite by weight (pph) which permits the washing step to be eliminated as taught and described in U.S. Pat. No. 4,895,713 the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1,10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 25° to 125° C. to promote reaction of the reducing agent and intercalant coating. The heating period is up to about 20 hours, with shorter heating periods, e.g., at least about 10 minutes, for higher temperatures in the above-noted range. Times of one-half hour or less, e.g., on the order of 10 to 25 minutes, can be employed at the higher temperatures.

Upon exposure to high temperature, e.g., temperatures of at least about 160° C. and especially about 700° C. to about 1200° C. or higher, the particles of intercalated graphite expand as much as 80 to 1000 or more times its original volume in an accordion-like fashion in the c-direction, i.e., in the direction perpendicular to the crystalline planes of the constituent graphite particles. The expanded, i.e., exfoliated graphite particles are vermiform in appearance, and are therefore commonly referred to as worms. The worms may be compressed together into flexible sheets, which, unlike the original graphite flakes, can be formed and cut into various shapes and provided with small transverse openings by deforming mechanical impact as hereinafter described.

Flexible graphite sheet and foil are coherent, with good handling strength, and are suitably compressed, e.g., by roll-pressing, to a thickness of about 0.003 to about 0.15 inch and a density of about 0.1 to about 1.5 grams per cubic centimeter. From about 1.5-30% by weight of ceramic additives, can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of 0.15 to 1.5 millimeters. The width of the particles is suitably from about 0.04 to about 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

The flexible graphite sheet can also, at times, be advantageously treated with resin and the absorbed resin, after curing, enhances the moisture resistance and handling strength, i.e. stiffness, of the flexible graphite sheet as well as “fixing” the morphology of the sheet. Suitable resin content is preferably at least about 5% to about 90% by weight, more preferably about 10 to 35% by weight, and suitably up to about 60% by weight. Resins found especially useful in the practice of the present invention include acrylic-, epoxy- and phenolic-based resin systems, polytetrafluoroethylene, polyvinyldifluoride, or mixtures thereof. Suitable epoxy resin systems include those based on diglycidyl ether or bisphenol A (DGEBA) and other multifunctional resin systems; phenolic resins that can be employed include resole and novolac phenolics. Other suitable types of resins include polytetrafluoroethylene, and polyvinyldifluoride.

Nonetheless, the graphite sheet as prepared above is cut and trimmed to form the desired articles. The methods of the present invention may use the above-described graphite sheets including the trimmed portions. More specifically, the process of the present invention may use the above-described graphite sheets including the trimmed portions at various stages of completeness, as discussed below.

Flexible graphite is one choice of a material of construction to form one or more elements of a fuel cell in the foregoing invention. Examples of such elements include a flow field plate, a gas diffusion layer, a gas diffusion substrate, an electrode, and combinations thereof. The invention is equally applicable to cylindrical fuel cells as well as planar fuel cells. For additional description regarding cylindrical fuel cells the specifications of U.S. patent applications filed on or about Jun. 28, 2002, granted Ser. Nos. 10/184,815 and 10/184,817, are incorporated herein by reference in their entirety. For additional description regarding planar fuel cells the specifications of U.S. patents, granted U.S. Pat. Nos. 6,413,633 and 6,413,671, are incorporated herein by reference in their entirety. The aforementioned patent applications and patents are incorporated herein to provide more description regarding at least the components of each respective fuel cell, how each type of fuel cell is constructed, and how each type of fuel cell operates.

The invention will be further defined in terms of the aforementioned drawings. In describing the aforementioned drawings, like or similar reference numerals will be used to describe like or similar elements in the various drawings.

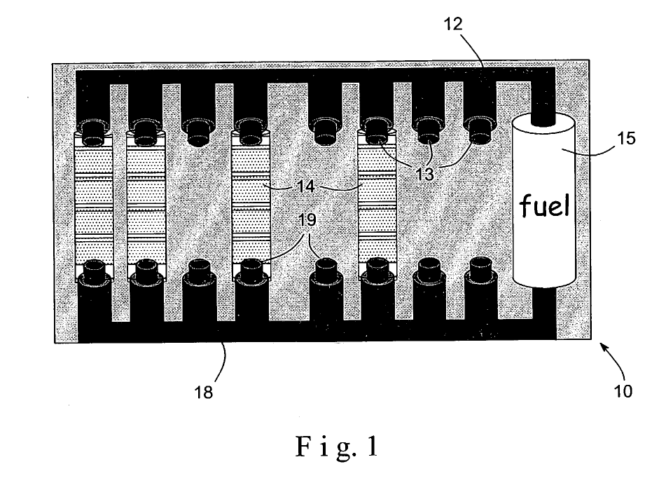

Illustrated in FIG. 1 is a power pack preferably for an electrical device, generally designated 10. Other terms for a power pack include a power source, a power supply, or a power supply package. Preferably power pack 10 includes a reactant supply element 12 for a reactant comprising one of a fuel or an oxidant. As illustrated, supply element 12 includes a plurality of reactant ports 13. In operation, the reactant enters supply element 12 through a reactant entrance port (not shown) and exits supply element 12 through one or more ports 13.

As for the reactants, the fuel may be any compound which may be converted into a proton and an electron, such that the proton may pass through a membrane. Examples of suitable fuels include hydrogen, hydrocarbons such as alcohols (methanol, ethanol, etc.), ammonia, ammonium containing compounds and combinations thereof. Examples of suitable oxidants include air, oxygen, and combinations thereof.

Supply element 12 may be comprised of any material that is suitable to deliver the reactant, preferably a material non-reactive with the reactant. Depending on the particular functional characteristics desired, supply element 12 may be composed of substantially electrically conductive material or substantially non-electrically conductive material. Most desirably, however, the material of construction of supply element 12 is chemically inert with respect to the reactant. Polymeric materials are one example of suitable material of construction. Polymeric material is used herein to describe a material, which comprises at least one of plastic, thermoplastic elastomer, and rubber. Other examples of suitable materials for the construction of supply element 12 include silica, quartz, natural graphite, synthetic graphite, carbon, metal, metal-alloy, and combinations thereof.

As shown in FIG. 1, power pack 10 includes a fuel reservoir 15. Supply element 12 is attached to fuel reservoir 15 in such a manner that fuel may flow from reservoir 15 into supply element 12. Preferably reservoir 15 is removably attached to pack 10. As depicted reservoir 15 is part of power pack 10, however, the invention is not limited to reservoir 15 being part of pack 10. Alternatively, reservoir 15 may be external to pack 10. In another embodiment, reservoir 15 is stored in a central aperture of cylindrical fuel cell 14. Reservoir 15 may be stored in the aperture through the use of the fuel cell having a closed end and a spring. A shunt or any other type of conduit may be used to connect reservoir 15 to supply element 12. Reservoir 15 is suitable for storage of the reactant in either gas or liquid form. Suitable materials of construction reservoir 15 include at least the same as supply element 12.

In the case of an electrical device that includes power pack 10 with the reactant reservoir, the power control for the device may be used to trigger a valve to supply the reactant to supply element 12 of power pack 10. For example, the reservoir may include a micropump or other type of micro-electro mechanical systems (“MEMS”) element which switches open when the power for the device is activated.

Preferably, power pack 10 may also include a plurality of cylindrical fuel cells 14. Reactant supply element 12 may be aligned with the plurality of cells 14 such that supply element 12 is capable of delivering the reactant to more than one of the cells 14 of the plurality. Supply element 12 may be in the form of a manifold in which the reactant may be supplied to each one of the fuel cells 14 or some combination of less than all of the fuel cells 14 in the plurality.

Preferably at least one of the plurality of fuel cells 14 comprises a proton exchange membrane fuel cell. More preferably at least about half the plurality comprise proton exchange membrane fuel cells. It is also preferred that at least one of the plurality of fuel cells comprises a graphite element, more particularly, a GDL primarily formed from or of graphite, in communication with a catalyst of the PEM fuel cell. Preferably the catalyst comprises one or more transition metals. More preferably the catalyst comprises at least one element of the platinum group of platinum, ruthenium, rhodium, palladium, iridium, molybdenum, and combinations thereof The catalyst may be in the form of an MEA or separate from the membrane, but still in contact with the membrane. In one preferred embodiment, the catalyst layer is an integral part of the GDL and the catalyst layer is on a surface of the GDL facing the membrane. Preferably the graphite element further comprises a plurality of transverse channels from a first surface of the graphite element to a second surface of the graphite element. Optionally at least one of the channels runs obliquely from the first surface to the second surface.

Fuel cell 14 may be removably attached from supply element 12. In one embodiment, port 13 of supply element 12 comprises a push socket, which will releasably hold an end of fuel cell 14. In another embodiment, cell 14 may have tapered end, which is releasably retained in port 13. In a further embodiment, fuel cell 14 may be releasably aligned with supply 12 through the use of a spring or a shunt.

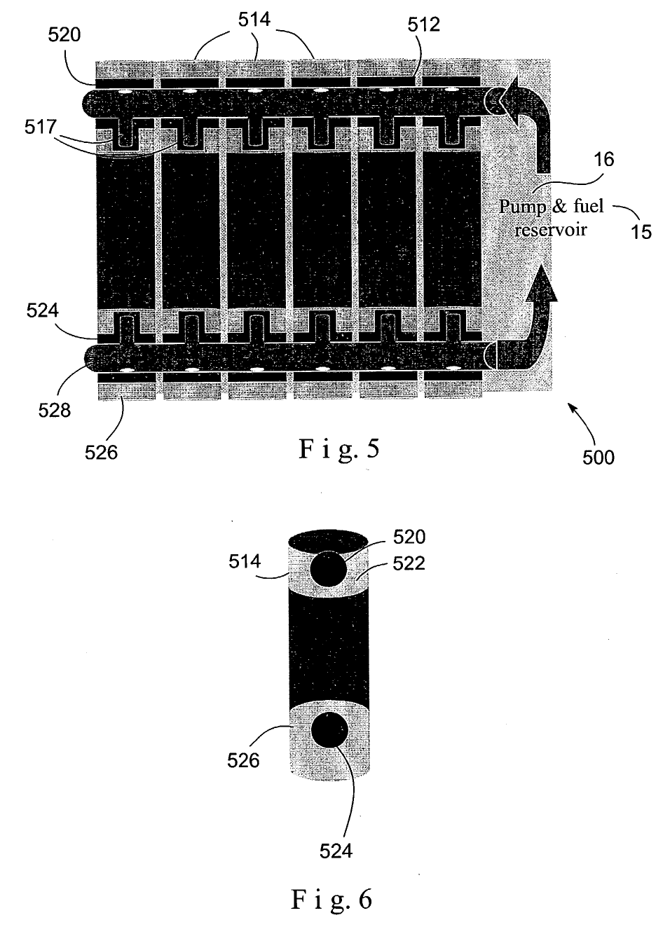

Optionally, power pack 10 may further comprise a pump 16 (FIG. 5) to supply the reactant to supply element 12. Additionally, pump 16 may be in fluid communication with a reservoir of the reactant. An alternate embodiment of pump 16 may comprise a capillary system to transport the reactant. Other optional features include that at least one of the fuel cells 14 may be removably attached to supply element 12. Preferably all of fuel cells 14 are removably attached to supply element 12. Power pack 10 may further comprise an exhaust line 18 and one or more exhaust ports 19 to remove reaction by-products from power pack 10. Additionally, power pack 10 may include a second reactant supply element to deliver either the oxidant if the fuel is delivered through reactant supply element 12 or the fuel if the oxidant is delivered through reactant supply element 12. Preferably, the second reactant delivery line would deliver the oxidant to respective individual fuel cells 14 and this may be referred to as an “active” power pack 10. Furthermore, power pack 10 may include a reactant recycle line along with exhaust line 18 or in place of exhaust line 18. As for power pack 10 itself, pack 10 may be removably attached to an electrical device or be an integral part of the device. Furthermore, instead of including line 18, a fuel cell 14 may be “dead-ended”, by which is meant that the fuel exit of fuel cell 14 is closed.

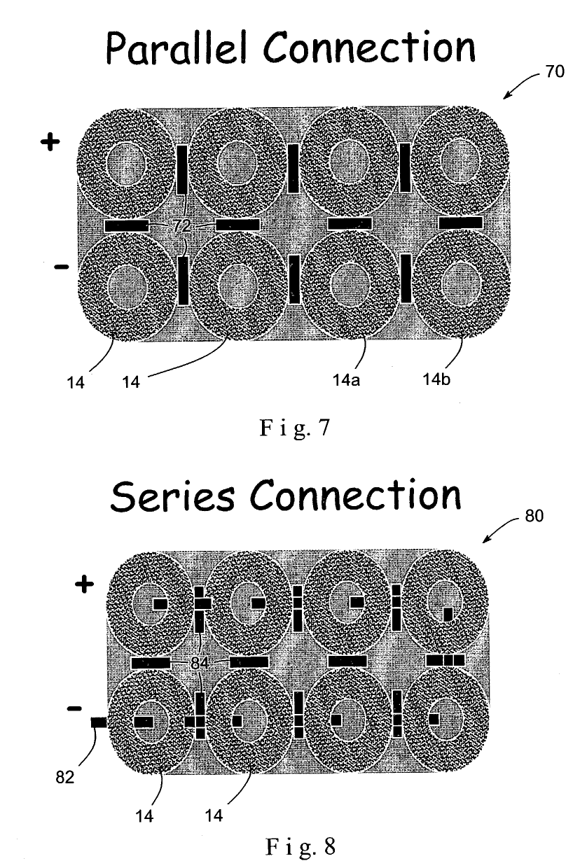

Illustrated in FIGS. 7 and 8, fuel cells 14 may be connected to each other in parallel, series, or some combination thereof. Depicted in FIG. 7, a plurality of fuel cells 14 (about eight (8) for illustrative purposes) are connected in parallel, generally designated 70. The fuel cells 14 are connected in parallel by element 72. In one embodiment, element 72 may comprise a conductive material, e.g., a metal wire or piece of flexible graphite, e.g., GRAFOIL® flexible graphite sheet available from Graftech Inc. of Lakewood, Ohio, in contact with the exterior surfaces of adjacent fuel cells 14, such as 14a and 14b. In this embodiment, preferably the exterior surface of each fuel cell connected in parallel is conductive. In a second embodiment, element 72 may comprise portions of an exterior surface of adjacent fuel cells 14 that are in contact with one another, without the use of the aforementioned metal wire.

Illustrated in FIG. 8 is a plurality of fuel cells 14 (about eight (8)) connected in series, generally designated 80. The plurality of fuel cells 14 is connected in series with a conductive element 82, e.g. a metal wire or GRAFOIL® material. Preferably element 82 is connected to the anode of one fuel cell 14 of the plurality and to the cathode of a second fuel cell 14 of the plurality or vice versa. The series connection configuration 80 also includes an insulator 84 between adjacent exterior surfaces of fuel cells 14.

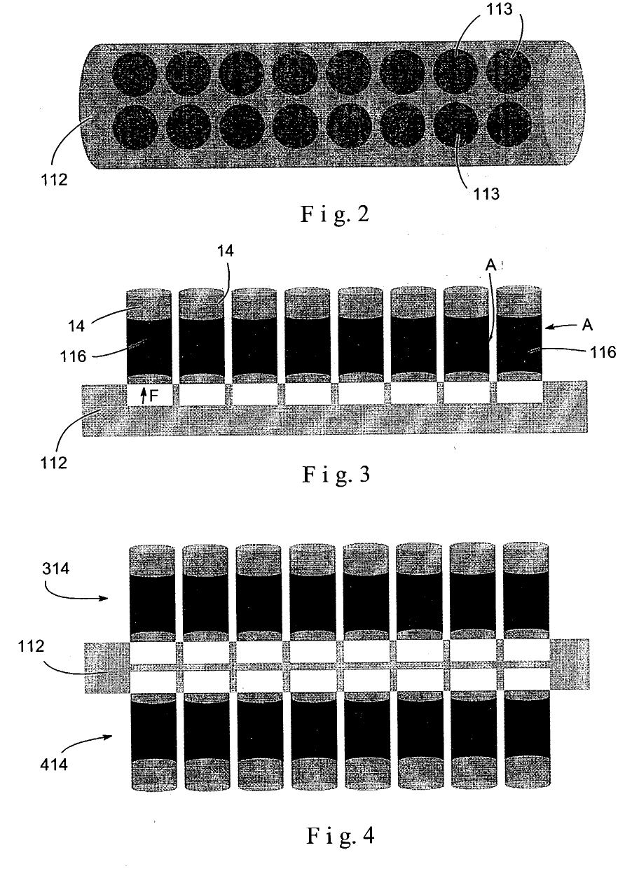

Another example of a supply element 112 is depicted in FIG. 2. Supply element 112 of FIG. 2 comprises a substantially cylindrical shaped object. The circumference of the object may have any suitable shape, e.g., circular, square, rectangular, etc. Preferably supply element 112 includes at least two or more reactant ports 113. The reactant ports may be aligned uniformly or non-uniformly along an outer surface of supply element 112. As shown, supply element 112 includes two rows of reactant ports 113. Supply element 112 is not limited to any particular number of rows of reactant ports. Preferably, supply element 112 further includes a central passage (not shown) to distribute the reactant throughout supply element 112. It is also preferred that port 113 is configured to receive a fuel cell. Preferably, the fuel cell will extend radially out from supply element 112.

As illustrated in FIGS. 3 and 4, fuel cells 14 may extend radially from supply element 112. FIG. 3 depicts one row of fuel cells 14 extending from supply element 112 in one direction. In FIG. 4, two rows of fuel cells 14 are illustrated. Each row of fuel cells 14 in FIG. 4 extends away from supply element 112 in a different direction.

In one embodiment, fuel flows from supply element 112 into each individual fuel cell 14 through a central aperture or central annulus like opening. The flow of the fuel as described herein is represented by arrow F of FIG. 3. As illustrated in FIG. 3, the oxidant, such as air, may enter cell 14 through a lengthwise exterior opening 116 or a plurality of lengthwise exterior openings 116. In the embodiment shown in FIG. 3, the exterior may be a gas diffusion layer. The air may enter cell 14 through one or more directions at the same time. As depicted in FIG. 3, air is entering cell 14 from two or more directions (see arrows A), more preferably all directions.

FIG. 3 may also be referred to as an embodiment of a passive power pack. In a passive power pack, air may be supplied to an interior of the power pack housing, but not directly supplied to any particular portion of the fuel cell. In a passive power pack, air flows into contact with a particular fuel cell 14 without the use of a pump or manifold system to direct the air into contact with the cathode side of a particular fuel cell 14. In one embodiment of a passive fuel cell, the cathode side of the individual fuel cells are exposed to ambient air. However, a passive system may include a fan to draw an oxidant into an interior cavity of a housing for the power pack. Also, the oxidant of a passive power pack is not limited to air.

A further embodiment of the inventive power pack is depicted in FIGS. 5 and 6, and generally designated 500. Pack 500 includes a supply element 512 and a plurality of fuel cells 514. As shown, supply 512 comprises a tube, preferably formed of a non-electrically conductive material. Tube 512 includes a plurality of openings (517). Preferably at least one opening of tube 512 is aligned to deliver the reactant to one of the fuel cells 514. More preferably, each fuel cell 14 has at least one respective opening of tube 512 aligned to deliver the reactant to the respective fuel cell. In a further embodiment, more than one opening in tube 512 may be used to deliver fuel to a particular fuel cell 514.

With respect to each fuel cell 514 in FIG. 6, it is preferred that each fuel cell includes at least one pair of, preferably radially opposed, openings 520 at one end 522 of fuel cell 514 to receive tube 512. It is further preferred that fuel cell 514 includes a second pair of, preferably radially opposed, openings 524 at a second end 526 of fuel cell 514 to receive an exhaust line 528. Similar to tube 512, exhaust line 528 preferably includes one or more respective openings aligned to receive one or more by-products from each fuel cell 514 of the plurality of fuel cells 514. Exhaust line 528 may constructed from the same material as supply element 512.

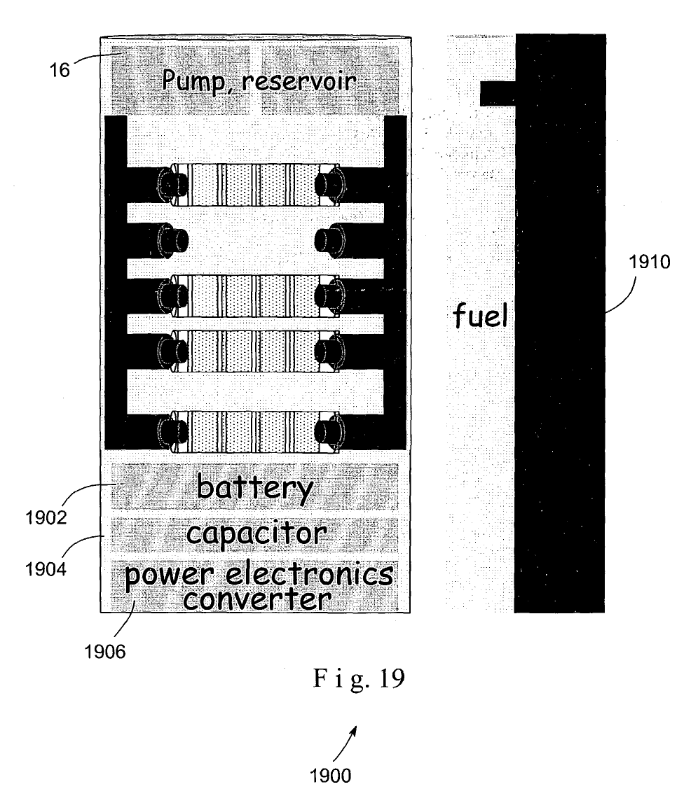

In addition to pump 16, the power pack 1900 may include a battery 1902 (e.g., a lithium ion battery or an alkaline battery), a capacitor 1904, or a DC-DC converter 1906, as illustrated in FIG. 19. The battery 1902 and the capacitor 1904 may used to provide the initial power to an electrical device or the battery 1902 and the capacitor 1904 may be used to provide back-up power or power while the subject electrical device is in a stand-by mode of operation. The DC-DC converter 1906 may be used to boast the power output of power pack 1900 in the case that power pack 1900 is not producing enough power for the associated electrical device. For example if power pack 1900 is only able to produce 1 volt of power, a DC-DC converter could be used to increase the power output to at least about 3.7 volts.

FIG. 19 also illustrates, alternatively, that the reactant reservoir 1910 may be separate from power pack 1900. As illustrated the reactant reservoir may comprise a cartridge 1910 that may be removably connected to pump 16. Cartridge 1910 may be attached to power pack 1900 by any of the means discussed herein.

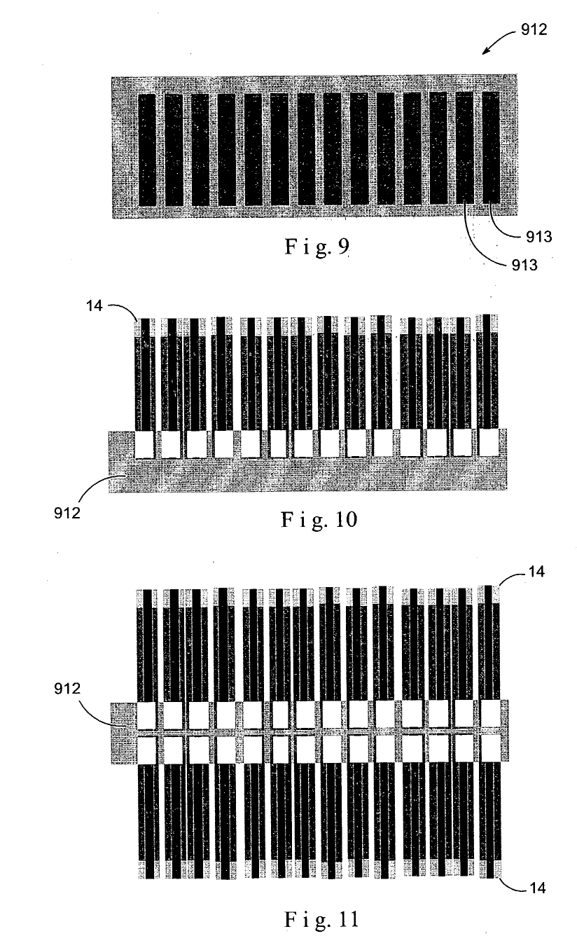

As stated, the invention is also applicable to planar fuel cells. One example of a supply element suitable for a plurality of planar fuel cells is depicted in FIG. 9, and generally designated 912. Supply element 912 includes a plurality of openings 913 to receive the planar fuel cells. Element 912 is similar to element 112, except for the configuration of openings 913 (rectangular) as compared to openings 113 (elliptical). The material of construction of each 112 and 912 can be the same.

Illustrated in FIGS. 10 and 11 are planar fuel cells in communication with supply element 912 in the same manner as shown in FIGS. 3 and 4. The supply element in FIGS. 10 and 11 differ from supply elements 112 in FIGS. 3 and 4, in that the openings to receive the plurality of fuel cells are similar to those illustrated in FIG. 9 and not like those illustrated in FIG. 2. Whereas, the openings for the plurality of fuel cells in FIGS. 3 and 4 are similar to like those illustrated in FIG. 2 and not like those illustrated in FIG. 9. With respect to all other aspects of supply elements 112 are the same or similar to those of supply elements 912.

Another embodiment of the inventive power pack includes a reactant supply element for a reactant comprising one of a fuel or an oxidant. The embodiment further includes a plurality of fuel cells attached to the reactant supply element wherein at least two of the plurality are removably attached to the reactant supply element. The plurality of fuel cells may include cylindrical fuel cells, planar fuel cells, or some combination thereof.

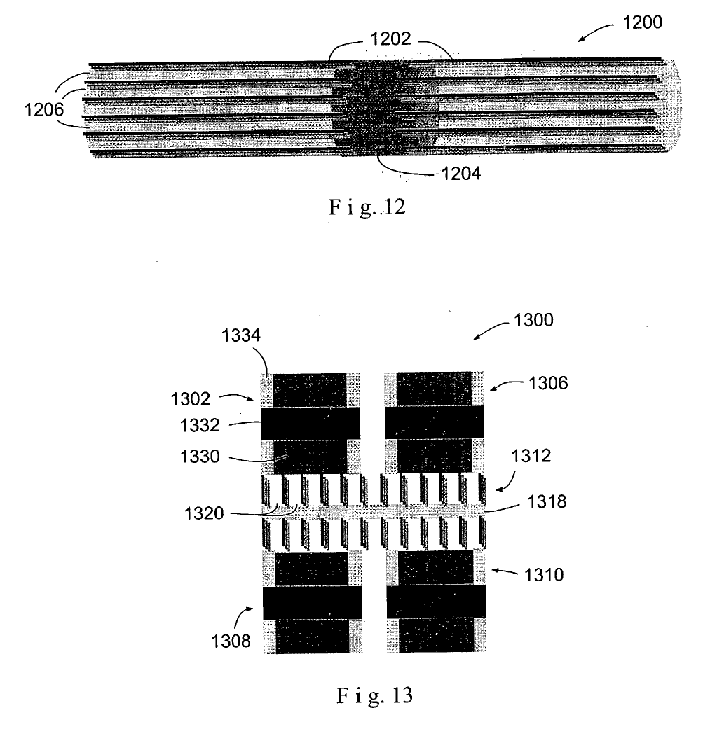

Preferably in a further embodiment of the inventive power pack, the reactant supply element comprises about 2 or more flow field plates 1202 and a non-conductive coupler 1204, as depicted in FIG. 12, generally designated 1200. Preferably, coupler 1204 maintains flow field plates 1202 in fluid communication. Preferably a reactant is supplied to one of flow field plates 1202 and the reactant may flow between each of the flow field plates 1202 connected together by coupler 1204. Preferably plates 1202 are removably attached to coupler 1204. An example of a material construction of coupler 1204 comprises a non-conductive polymer. Coupler 1204 may be connected to plates 1202 by compression, adhesive, threaded joints, or other known techniques. In operation the reactants are charged into one of the flow field plates 1202. The reactant fills channels 1206 of flow field plate 1202 and can either flow through coupler 1204 and into an adjacent flow field plate 1202 or the reactant can flow into a fuel cell associated with each respective flow field plate. Preferably, each flow field plate is aligned vertically or horizontally to a respective fuel cell (for example see FIG. 13). It is also preferred that the fuel cell is removably attached to the respective flow field plate 1202 by compression or other techniques discussed above. As shown in FIG. 12, the two flow field plates 1202 are connected substantially in series.

Two or more fuel cells connected in parallel are illustrated in FIG. 13, generally designated 1300. Power pack 1300 includes a flow flied plate 1312 having a center passage 1318 and a plurality of radial passages 1320 extending out from center passage 1318. Power pack 1300 further includes four (4) fuel cells 1302, 1306, 1308, and 1310, which extend radial from flow filed plate 1312. Each one of the fuel cells 1302, 1306, 1308, and 1310 are aligned to receive a reactant from one or more of the radial passages 1320. Preferably each fuel cell includes an electrode (1330) comprising a GDL and a catalyst attached to the GDL. A membrane (1332) is in communication with electrode 1330, and a second electrode 1334 is attached to membrane 1332. Second electrode 1334 may be the same as electrode 1330. In an alternate embodiment, flow field plate 1312 may include two or more flow field plates connected together, similarly to as shown in FIG. 12. In the alternate embodiment, the flow field plates may be attached by coupler 1204, as described above.

In operation, the reactant enters power pack 1300 through passage 1318 of flow field plate 1312. The reactant exits flow field plate 1312 through one of the radial passages 1320 and into one of the four fuels cells adjacent flow field plate 1312. Preferably the aforementioned flow field plate is constructed from a substantially electrically conductive material, e.g., flexible graphite.

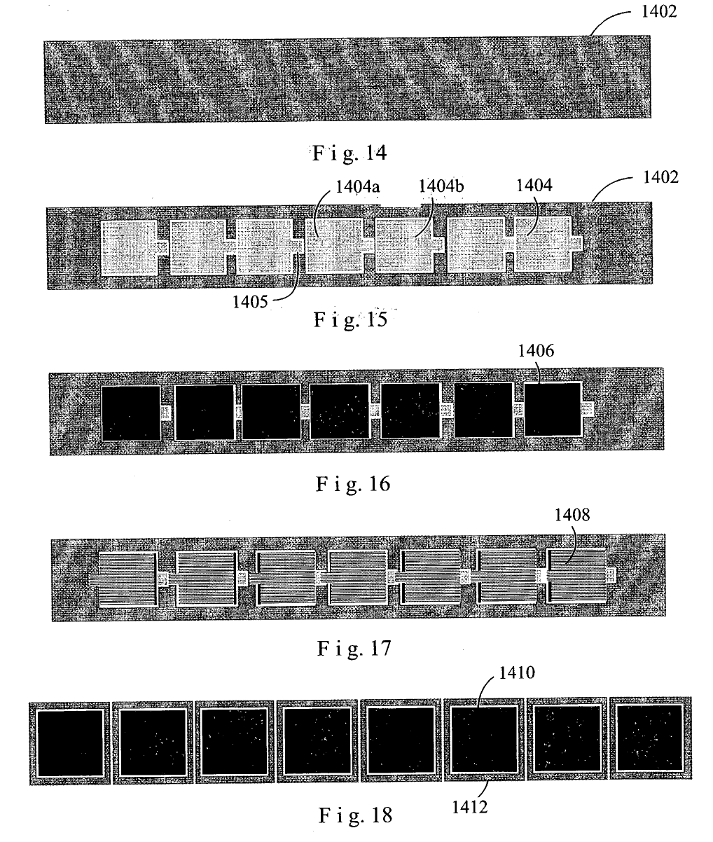

Illustrated in FIGS. 14-18 is a method of making a plurality of planar fuel cells connected in series. Depicted in FIG. 14 is a substrate 1402, preferably substrate 1402 comprises a flow field plate. Substrate 1402 may be formed from conductive or non-conductive material. For example, substrate 1402 may be constructed from a conductive polymer, a non-conductive polymer, metal, metal-alloy, cellulose material, and combinations thereof. Substrate 1402 may function as a supply element. Preferably, flow channels may be embossed or molded into substrate 1402. Next, a gas diffusion layer 1404, preferably a gas diffusion layer formed from flexible graphite such as GRAFOIL® sheet, available from Graftech Inc. of Lakewood, Ohio is applied to substrate 1402, as shown in FIG. 15. Preferably, each GDL 1404a includes a connection element 1405 attached to an adjacent gas diffusion layer 1404b. Optionally, gas diffusion layer 1404 may be laminated onto substrate 1402. Gas diffusion layer 1404 may comprise a non-perforated region, preferably a perimeter region. The nonperforated region may comprise flexible graphite, a polymer, and combinations thereof.

Alternatively, gas diffusion layer 1404 may comprise a combination of a flow field plate and gas diffusion layer. In the case that gas diffusion layer 1404 includes a flow field plate, substrate 1402 may not function as a flow field plate. In another alternative, gas diffusion layer 1404 may comprise an electrode. In the case that gas diffusion layer 1404 includes an electrode, a catalyst layer is applied to gas diffusion layer 1404.

In one embodiment in of FIG. 16, a membrane electrode assembly 1406 is stamped onto the gas diffusion layer 1404. Non-conductive areas of assembly 1406 may be attached to the gas diffusion layer 1404. Adhesives such as polyethylene or any other suitable type of sealant may be used to seal assembly 1406 to gas diffusion layer 1404. Alternatively, in the case that gas diffusion layer 1404 comprises an electrode, assembly 1406 may be substantially free of a catalyst layer adjacent electrode 1404. Depicted in FIG. 17, a second gas diffusion layer 1408, and optionally a flow field plate, is pressed onto the membrane electrode assembly 1406 to complete each fuel cell. Gas diffusion layer 1408 may also comprise a connection element to connect the adjacent gas diffusion layers 1408 in series. All alternatives of gas diffusion layer 1404 also apply to gas diffusion layer 1408.

In the case that a flow field plate is not included with gas diffusion layer 1408, FIG. 18 may depict applying a flow field plate 1410 to gas diffusion layer 1408. In that case the 1408 represents the cathode side of a fuel cell, FIG. 18 may depict the application of a porous material, e.g., polytetrafluoroethylene, to each individual fuel cell. Preferably, the porous material will allow an oxidant, such as air, to enter the completed fuel cell.

In one embodiment, the fuel travels along supply element 1402 into fuel cells 1412 which make-up the plurality. Additionally, air, as the oxidant, is introduced into fuel cells 1412 through gas diffusion layer 1408 open to the atmosphere. The air may be forced air. Furthermore, individual pluralities of fuel cells 1412 may be stacked on top of each other for higher voltage output requirements.

The invention may further include an electrical device. Preferably, the device includes a power source comprising at least reactant supply element 12 and a plurality of cylindrical fuel cells 14. Preferably reactant supply element 12 is aligned with the plurality and supply element 12 is able to deliver the reactant to more than one of the plurality of fuel cells. It is further preferred that the device comprises at least one of a cellular telephone, a pager, digital video equipment, a personal digital assistant, or a portable computer (AKA laptop). Preferably, the power source is connected to the device to supply power to the device. Personal digital assistants (PDAs) are portable devices that can keep track of information such as a calendar, contacts and email. PDAs can also exchange information with PCs and other PDAs, download music, and provide access to the internet. Digital cameras use electric light sensors in place of film to record images and store them as data files. These files can then be downloaded to a computer, edited and printed. Most digital cameras include reusable, removable memory cards or sticks, which offer potentially unlimited picture storage capabilities. Images can be viewed instantly on the camera's LCD monitor. The images may be stored or deleted.

One application of the inventive power pack is for the micro supply of power to devices. This is defined herein for a power pack that may deliver about 100 watts or less of power to a device. Examples of suitable amounts of power for an inventive power pack to deliver comprise about 50 watts or less, about 10 watts or less, or about 5 watts or less.

The above description is intended to enable the person skilled in the art to practice the invention. It is not intended to detail all of the possible variations and modifications, which will become apparent to the skilled worker upon reading the description. It is intended, however, that all such modifications and variations be included within the scope of the invention, which is defined, by the following claims and the equivalents of the claims. The claims are intended to cover the indicated elements and steps in any arrangement or sequence, which is effective to meet the above advantages intended for the invention, unless the context specifically indicates the contrary.

What is claimed is:

1. A power pack comprising
a reactant supply element for a reactant comprising a fuel; and
a plurality of fuel cells attached to said reactant supply element and said power pack comprises a passive oxidant supply.

2. The power pack according to claim 1 wherein at least two of said plurality removably attached to said reactant supply element.

3. The power pack according to claim 1 wherein at least one of said fuel cell comprises at least a flexible graphite gas diffusion layer.

4. The power pack according to claim 3 wherein said gas diffusion layer comprises at least one perforated region.

5. The power pack according to claim 4 wherein said gas diffusion layer further comprises at least one non-perforated region.

6. The power pack according to claim 3 further comprising a flow field plate in communication with said gas diffusion layer.

7. The power pack according to claim 6 wherein a material of construction of said flow field plate comprises polymeric material.

8. The power pack according to claim 1 further comprising a fuel reservoir.

9. The power pack according to claim 8 wherein said fuel reservoir comprises a cartridge removably attached to said power pack.

10. The power pack according to claim 1 wherein at least two of said plurality of fuel cells attached in series.

11. The power pack according to claim 1 further comprising at least a second plurality of fuel cells attached to said reactant supply element.

12. The power pack according to claim 1 wherein at least two of said plurality of fuel cells attached in parallel.

13. An electrical device comprising a power pack according to claim 1 attached to said device in a manner to provide electricity to said device.

14. The electrical device according to claim 13 wherein said pack removably attached to said device.

15. The electrical device according to claim 13 wherein said device comprises a cellular telephone.

16. A method of making a power pack comprising:
attaching a plurality of fuel cells to a fuel supply element; and
passively supplying an oxidant to at least two of said fuel cells.

17. The method according to claim 16 further comprising connecting at least two of said fuel cells in series.

18. The method according to claim 16 further comprising assembling said plurality of fuel cells and said supply element in a chamber and pumping an oxidant into said chamber.

19. The method according to claim 16 wherein said attaching of at least two of said fuel cells to said supply element comprises removably attaching.

20. The method according to claim 16 wherein said passively supplying comprises aligning said fuel cells relative to each other of said fuel cells, said supply element, and said power pack such that an oxidant may be applied to an external surface of at least two of said fuel cells from an ambient atmosphere around said external surface of each of said at least two fuel cells.

21. The power pack according to claim 6 wherein a material of construction of said flow field plate comprises flexible graphite.
